(19) United States
(12) Patent Application Publication
(10) Pub. No.: US 2013/0008589 A1
(43) Pub. Date: Jan. 10, 2013

(54) METHOD AND APPARATUS FOR THE MANUFACTURE OF LABELS

(76) Inventor: Wilhelm Kreutz, Koln (DE)

(21) Appl. No.: 13/572,646

(22) Filed: Aug. 11, 2012

Related U.S. Application Data
(63) Continuation-in-part of application No. PCT/EP2011/052021, filed on Feb. 11, 2011.

(30) Foreign Application Priority Data
Feb. 11, 2010 (DE) 10 2010 001 794.9

(51) Int. Cl. B32B 37/14

(52) U.S. Cl. 156/185; 156/280; 156/226; 156/390

(57) ABSTRACT

In a method for producing domed labels consisting of a base layer having a lower face provided with an adhesive layer, a cover layer connected to an upper face of the base layer and a support layer adhering removably to the adhesive layer, wherein: a composite comprising the base layer, the adhesive layer and the support layer is provided on a surface of the base layer that faces away from the adhesive layer with a quantity of a material of the cover layer in a flowable state by means of a dosing unit, the final shape of the cover layer being formed by means of a flow process of the material on the surface of the base layer and the material of the cover layer present in the final shape thereof being a least partially cured.

This is a Continuation-In-Part application of pending international patent application PCT/EP2011/052021 filed Feb. 11, 2011 and claiming the priority of German patent application 10 2010 001 794.9 filed Feb. 11, 2010.

### BACKGROUND OF THE INVENTION

The invention resides in a method for the manufacture of labels which consist of a base layer provided at their bottom side with an adhesive layer, a cover layer disposed on, and connected to, the top side of the base layer and a support layer which releasably adheres to the adhesive layer, the method comprising the following steps:

a) to the surface of a composite consisting of the base layer, the adhesive layer and the support layer a quantity of the cover layer material in a flowable state is applied at different spaced locations by means of a dosing device wherein the flowable material forms by a flow distribution the final shape of the cover layer and

b) The material present in the final shape of the cover layer is then at least partially cured.

Furthermore, the invention resides in an arrangement for the manufacture of labels which comprise a base layer which is provided at the bottom side thereof with an adhesive layer, a cover layer connected to the top of the base layer and a support layer which removably adheres to the adhesive layer, comprising:

a) a dosing arrangement by which a quantity of the material of which the cover layer consists can be applied in a flowable state to the surface of the base layer opposite the adhesive layer which forms a composite with the adhesive layer,

b) a transport arrangement by which the composite of the base layer, the adhesive and the support layer is movable relative to the dosing arrangement in such a way that the flowable material of the cover layer can be applied to the top side of the composite at different locations which are spaced from one another,

c) a curing or hardening arrangement by which the material of the cover layer present in its final shape can be at least partially hardened by means of radiation and/or temperature and/or pressure and/or air contact and/or an addition of at least one chemical compound wherein the composite remains in an essentially horizontal orientation in the dosing arrangement the curing arrangement and also in the intermediate areas.

### STATE OF THE ART

Labels of the type disclosed above are often called “domed”. This concerns a technology of manufacturing curved or arched generally transparent or translucent layers (dome) in any color, called above cover layer on imprinted or plain foils, called above “base layer” or on otherwise shaped bodies. The typically convex shape of the coating is obtained by the distribution of the originally flowable resin upon application to the surface. The flow distribution is stopped at the edges of the base layer by the surface tension of the material where the resin is stopped and cures. By means of this dosing technology the result in particular with regard to optical effects as well as the haptic quality of printed materials, brochures, advertising material and similar products can be noticeably improved. The dosing technology is therefore very much liked because it effectively supports advertising targets and sales success.

In the context with the present invention, labels are to be considered any adhesive markings of any shape. As examples, but not limiting for the application of domings the following are mentioned:
Labels and stickers of any shape,
premium signs with inscriptions, logos and picture grams (on stainless steel, bronze, glass, Plexiglas, and coated aluminum),
prestigious building—and object designations in inside and outside areas (in particular 3D inscriptions on glass doors,
automobile inscriptions with 3D logos and words,
inscriptions an advertising structures (automobile keys, rulers, name plates, buttons, etc.)
decorative marking of apparatus and equipment with 3D inscriptions,
exhibition stand designs with 3D inscriptions or logos.

For the manufacture of domed labels, resins on the basis of polyurethane, epoxy or isocyanate-free UV hardening doming resins are used (the latter being sold for example by the company SuraChemicals under the trade name “SureACer®”).

Top layers on the basis of epoxy resins are hard-elastic and have no flexibility. They are not really useable for outdoor applications since they have no UV stability and therefore tend to yellow. In addition, the pot life of the material which is available only in two-component form is several minutes which results in a technically economically and financially costly processing. Furthermore, the epoxy resins include poisonous and aggressive components which lead to ecological toxic loads and unhealthy effects (possible skin irritations). Whereas, consequently with a manual doming manufacturing method, in small number manufacturing there are certain advantages over other technologies, epoxy reasons are, because of the disadvantages mentioned above, not suitable for industrial manufacturing methods.

As second material group, the use of polyurethane is known as material for providing doming cover layers. Polyurethane resins are air-drying wherein the drying process occurs slowly and requires up to several hours and also depends on the humidity in the air. After hardening the doming has a high flexibility and, because its high UV and climate stability, such doming labels are also well-suited for outdoor applications Also, the polyurethane resin is available with only as a two-component resin and is available for processing within an only relatively short pot time, which again results in a relatively high technical processing expenditure. Also, with the processing of polyurethane resins, toxic parts of the components (Isocyanate) are a problem concerning the environment in general and the manufacturing personnel in particular. The classification of the isocyanates as poisonous compounds results in the logistics area in high storage and transport expenses. Also, the special waste removal requirements for the leftover material causes additional financial expenditures.

Finally, there are the UV hardened doming resins (for example, SurACer®) for the doming manufacture. This is a light-hardened, in particular, a UV-hardened resin system which is characterized by a very short hardening time (a few minutes) wherein air humidity does not affect the hardening process and the hardening time. Like polyurethane resins, UV-hardened resins are suitable for outdoor applications because of their UV—and clima stability. The material is considered to be handled easily since it has a very long pot life (with cooling several days), requires little effort for mixing and dosing tasks and is available in single and two-component form.

There is essentially no pollution during handling of the material since the material consists of nontoxic components which are not dangerous for people and are not rated to be poisonous components for transport or storage conditions. Because of the very low ecological pollution, cleanup of the waste material occurring during the production via regular commercial waste collection services is possible. Altogether, the doming production is comparatively efficient which permits the use of this material also in industrial manufacturing facilities.

The known methods for doming manufacture however have the disadvantage that the productivity is low and the apparatus expenditures are high. Labels are arranged on rectangularly shaped sheets of the carrier layer (typically in the A4 or A3 format) wherein the base layer is machined already before the application of the top layer by stamping in such a way that the material of the base layer is removed or can be removed between adjacent spaced labels. On a kind of dosing table, the sheets and the dosing arrangements (typically in the form of a dosing needle) are moved relative to each other in such a way that a matrix type array of gaps and lines of the label are obtained on the sheets. For producing domings with complex geometries, a particular method of application of the top layer material on the base layer may be used. Subsequently, the sheets with the not yet hardened domings are finally hardened in the case of air-hardened system in hardening arrangements in several layers alone by air contact or supported by heat treatment. In case of light hardening resin systems, the hardening step is performed in a hardening arrangement in the form of a chamber in which the cover layer is subjected to UV radiation. Under the term of “essentially horizontal orientation” herein also deviation of an exactly horizontal orientation of less than 10° are to be understood. However, also with slight deviations from an exactly horizontal orientation a fully controlled and adjustable distribution of the material of the cover layer must be possible. In particular, an uncontrolled running of the cover layer caused by gravity must be avoided.

It is herein particularly difficult and disadvantageous that the sheets to which the top material is applied need to be transferred from the dosing arrangement to the hardening arrangement and that, until the hardening is completed, any dust deposition on the surface of the top layer must be prevented since this would reduce the surface quality to such an extent that it could lead to the respective domings to be discarded. The maintenance of clean room conditions in large production areas that is space volumes requires substantial technical installations and financial expenses in connection with the known methods.

U.S. Pat. No. 4,008,115 discloses a method for the manufacture of durably coated labels. The composite of a base layer, an adhesive layer and a support layer is provided in the form of a web which is wound into a roll and which is subsequently coated by a resin in three roller stations arranged one after the other. The whole coating layer thickness is about 7.6 μm. The mechanism for the coating of the composite with the material of the cover layer is an arrangement similar to that used in the printing technology wherein the cover layer material is applied over the whole surface of the composite that is in particular also in the areas between the adjacent labels. By a flow-movement, the cover layer material covers also the side surface areas of the base layer and the adhesive layer as well as the support layer in the areas between the adjacent labels, wherein there, because of the cohesion forces in the material in connection with the special surface properties of the silicon coating of the support layer, a kind of droplet or raised rope-like areas are formed. There is the chance that the droplet- or rope-like projections connect to the cover layer material at the edges of the labels and, in this way, result in an adhesive jointure of adjacent labels. In addition, the consumption of cover layer material is unnecessarily high since the excess material collected between the adjacent labels is lost. In addition, the expenses for the apparatus for the coating is high since it is applied in three subsequent stations which are arranged vertically on top of one another and in each station only a partial coating with the cover layer can take place.

In addition, U.S. Pat. No. 4,253,899 discloses a method for the manufacture of labels wherein the cover layer is present in the form of an endless film already before the connection to the composite.

Finally, U.S. Pat. No. 4,759,982 discloses a method for the manufacture of labels wherein the cover layer is applied by means of a screen printing method. Herein, the end faces of the labels extending normal to the composite are intentionally covered and sealed by the cover layer material. The thickness of the transparent cover layer which also has a protection function is in accordance with this method between 0.01 mm and 0.1 mm.

It is the object of the present invention to provide a method and an apparatus for the manufacture of domed labels by which the domed labels can be manufactured in a particularly efficient and cost-effective manner.

### SUMMARY OF THE INVENTION

In a method for producing domed labels consisting of a base layer having a lower face provided with an adhesive layer, a top layer connected to an upper face of the base layer and a support layer adhering removably to the adhesive layer, wherein: a composite comprising the base layer, the adhesive layer and the support layer is provided on a surface of the base layer that faces away from the adhesive layer with a quantity of a material of the top layer in a flowable state by means of a dosing unit, the final shape of the cover layer being formed by means of a flow process of the material on the surface of the base layer and the material of the cover layer present in the final shape thereof being a least partially cured.

The composite is preferably in the form of a web unwound from a storage roll, and, after application of the top layer is again rewound, onto another roll.

The supply of the material in the form of a web that is its unwinding from a storage roll permits a particularly efficient manufacture since a complicated and bothersome handling of sheets is omitted. The invention, as a result, permits in the manufacture of the domed labels a continuous flow process that is, it does not require the use of a batch processing method as it has so far been common (batch production with a sheet as a batch). A large advantage of the process according to the invention resides in the fact that the finished domed labels are again present in web form after the hardening of the cover layer and can be wound onto a roll. Such a roll of finished domed labels may be used in a common labeling apparatus so that also the procedure of attaching the domed labels is simplified over the state of the art. After all so far, the domed labels had to be removed by hand from the respective sheet and applied to the respective location where they were needed. Alternatively, if not by hand, the finished domed labels can also be removed from the sheet by complicated grasping arms and applied to the product to be identified or marked thereby.

As a result of maintaining the horizontal orientations of the composite between the application of the top layer material and the at least partial hardening, a controlled distribution of the top layer material is ensured and in particular, an uncontrolled flowing of the not yet hardened material is prevented. Slight deviations of an exactly horizontal orientation are however acceptable as long as the desired distribution of the cover layer material up to the final hardening can be guaranteed.

Preferably, the composite consisting of the base layer, the adhesive layer and the support layer is unwound from a roil forming a store for the application of the top layer material and the composite of the base layer, the adhesive material, the support layer and the hardened top layer is re-wound onto a roll.

Furthermore, it may be advantageous if the composite of the base layer, the adhesive layer and the support layer is unfolded before the application of the top layer from a storage packet in which the composite is folded as a leporalo and the composite of the base layer, the adhesive layer and the support layer and the at least partially hardened top layer is re-folded to a finished packet in the form of a leporalo. Before or after the application of the top layer material, any desired combination of a roll-like winding or a leparolo type folding of the web is possible.

In order to further improve the productivity of the method according to the invention, the material of the fop layer can be applied to composites disposed on the web side-by-side in the direction normal to the transport direction. In this case, the web is wider and provided with several parallel paths on which doming labels are produced in parallel, the web being separated in longitudinal direction before or after the application of the top layer material in order to use it later as single label row web in an application apparatus.

Alternatively to the application in several paths, it is also possible to apply the top layer at several locations of one path (in transport direction adjacent locations). The productivity can be increased also in this way.

A particularly small consumption of top material is achieved and, at the same time, an undesired adhering of adjacent labels to each other is avoided if exclusively utilization areas of the base layer are coated with the top layer material but the spaces between the utilization areas remain free of top material. In particular, in this connection, a disconnection of the composite before the application of the top material would be appropriate that is in the intermediate spaces at least the material of the base layer and preferably also of the adhesive layer is removed.

The labels manufactured in accordance with the invention have a particularly attractive appearance if the top layer has a convex shape. The thickness of the top layer in the final form should foe between 0.5 and 2 mm, preferably between 1.0 mm and 2 mm.

Top layers of large material thickness can be achieved in connection, with a correspondingly high viscosity of the top layer material by the application of the material, via a nozzle via which the material is applied in a continuous flow and is deposited in this way onto the base layer. Herein the flow cross-section of the nozzle may be essentially smaller than a cross-sectional area of the top layer finally present on the finished label, since because of the flow properties of the fop layer material, a uniform distribution is achieved. In particular, circular labels with corresponding circular top layers can be easily obtained in this way if the top layer material is applied at a central location on the surface of the utilized area of the base layer from which it flows uniformly outwardly.

As far as the technical arrangement is concerned, the object of the invention is solved with an apparatus of the type described initially by providing transport rollers by which the composite consisting of the base layer, the adhesive layer and the support layer present in the form of a web can be moved at least from an area ahead of the dosing arrangement up to the dosing arrangement. The invention consequently involves a continuous process of supplying the composite. It is also within the scope of the invention to disintegrate the web after the manufacture of the labels and to further process them individually as well as continuing the transport of the composite away from the dosing arrangement with the aid of additional transport rollers. The last mentioned variant is generally preferred since the whole procedure can be performed in this way continuously and the additional advantage can be obtained that the web wound up to a roll with completed labels can later be inserted into a labeling apparatus for a continuous deployment of adhesive domed labels.

In accordance with the invention, there is furthermore a roller bearing support arrangement for a roll comprising the web which consists of the composite including the base layer, the adhesive layer and the support layer before the application of the top layer material. From such a roller bearing support arrangement, a web providing the unfinished material for the manufacture of a large number of labels can be continuously removed over a long period of time.

For high efficiency of the apparatus, a preferably motor operated roller support arrangement is provided for supporting a roll taking up the web of composites with the hardened top layer. With such an arrangement, the web is moved from one roll to another so that the web is unwound only for the purpose of finishing the labels and only in the area of the dosing arrangement and the hardening arrangement whereas otherwise only rolls of materials need to be handled. In spite of a high manufacturing capacity such an arrangement requires relatively little space.

In a particular embodiment of the invention, the hardening arrangement and/or the dosing arrangement are provided with a tunnel via which air-based particles can be kept away from the surface of the top layer before it is hardened. To this end, the tunnel has at its entrance cross-section and its exit cross-section corresponding shields which prevent ambient air which may carry particles from entering.

In a particularly advantageous embodiment, at least one dosing element of the dosing arrangement which supplies a top layer material stream is movable in a direction transverse and/or parallel to the transport direction. Such movability permits the generation of complex geometries on the domed labels wherefor a relative movability of the dosing element (typically a dosing needle) and the composite to be coated is required.

Finally, in another embodiment of the invention an accommodation structure is provided between the hardening arrangement and a take-up roll for winding up the web provided with the finished labels which accommodation structure includes an extender element which acts on the topside of a loop formed by the web wherein the extender element applies a constant downward force, in particular only the weight force of the extender element, to the web so that the web is slightly tensioned but the extender element is retractable by a drive means in order remove any force from the web for winding the web onto a storage roll. The web is continuously pulled through the dosing arrangement and the hardening arrangement in a predetermined way but is wound onto the roll intermittently when a sufficient length with hardened labels has been collected. The force-free winding up of the web without the need for web advancement by the web transport arrangement through the hardening and dosing arrangement is important in order to provide for the least possible web tension on the storage roll. This is important to avoid the undesirable radial roll tension which may cause undesired deformation of the labels in a labeling apparatus.

The invention will become more readily apparent from the following description of particular embodiments with reference to the accompanying drawings.

### BRIEF DESCRIPTION OF THE DRAWINGS

FIG. 1 shows, in a longitudinal cross-sectional view, the arrangement for the manufacture of domed labels,

FIG. 2 is a sectional view of a web-like composite structure,

FIG. 3 shows the structure of FIG. 2 with the top layer disposed on the composites and

FIG. 4 shows a section of FIG. 1 showing additionally the accommodation structure.

### DESCRIPTION OF A PARTICULAR EMBODIMENT

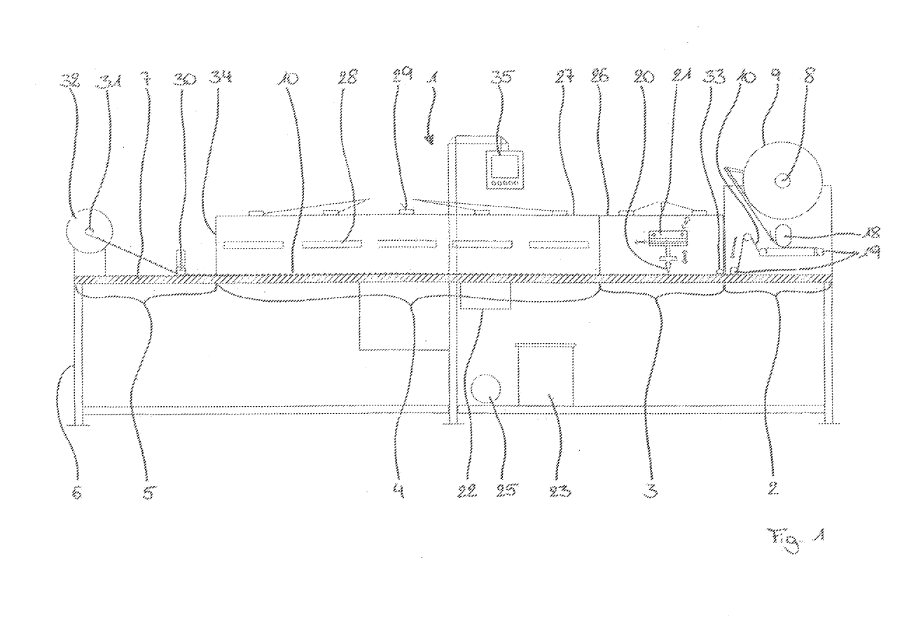

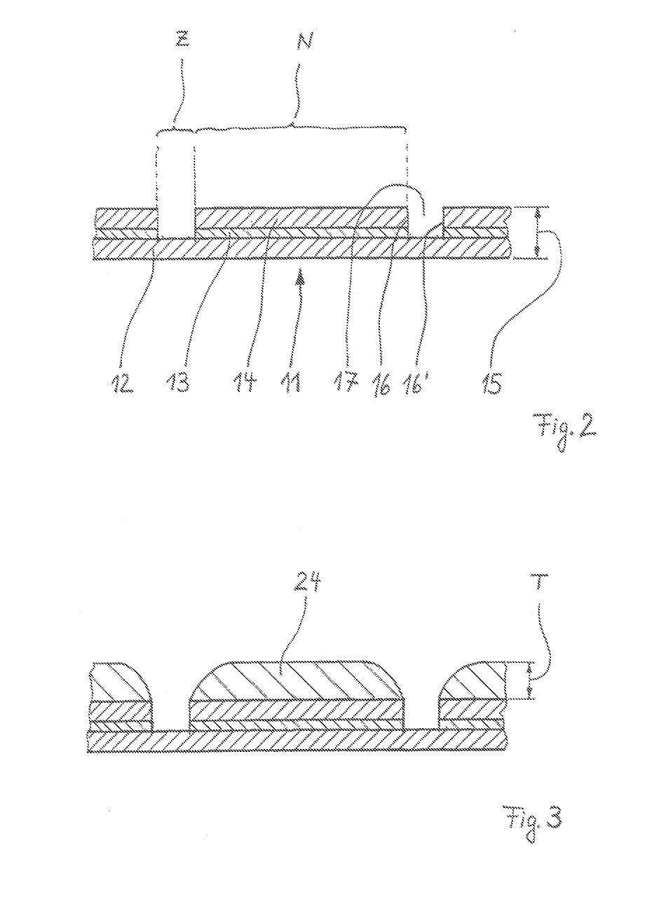

An arrangement 1 for the manufacture of domed labels as shown in FIG. 1 in a longitudinal section view consists of the essential design groups comprising an unwinding arrangement 2, a dosing arrangement 3, a hardening arrangement 4 and a rewinding arrangement 5. All of the above mentioned design groups are arranged on a table-like frame 6 whose top side is formed by a table top plate 7. The unwinding arrangement 2 includes a roll support 8 for a roll 9 which is formed by a web 10. The web comprises a composite which is formed by adhesion procedures and whose design features are described in greater detail with regard to FIG. 2.

The composite 11 comprises a support layer 12 on which by means of an adhesive layer 13, a base layer 14 is disposed. The base layer 14 may consist of paper or a foil. In a known manner, the composite is with regard to its thickness partially punched so that the base layer 14 and the adhesive layer 13 are severed whereas the support layer 12 is essentially undisturbed and is capable of providing for a safe transport of the web 10 ahead of the dosed deposition of the top layer as well as afterwards. In FIG. 2, two-punching lines 16, 16′ are schematically shown which—as seen in a top view of the composite 11 each forms a circle which represents the base area of the later domed label. Between adjacent circles and around the annularly surrounding punching areas 16, 16′, there is in each case a waste area 17 of the base layer 14 and the adhesive layer 13 which area is removed before the winding of the composite 11 onto a roll so that the areas of the later labels is marked by raised areas of the base layer 14. The process of removing the coherent waste areas 19 is called “migrating”. The areas of the base layer 14 which later are provided with the top layer 24 will be called below utilization areas N. Areas disposed in between will be called intermediate areas Z.

Below the roll 9, there is a drive unit 18 for driving the web 10. In connection with the drive unit 18, there are various transport rollers 19 which are in the form of reversing rollers for controlling the path of the web 10.

Next to the unwinding arrangement 2, there is the dosing arrangement 3 whose essential components are dosing element 20 in the form of a dosing needle and a positioning arrangement 21 in the form of an X-Y-Z positioning table. With the aid of the positioning table and a control arrangement 22 for the drives of the positioning table and for the web drive, the dosing needle can be moved in a vertical direction (Z direction) as well as also in a horizontal plane parallel to the longitudinal direction of the web (X-direction) and also normally thereto (Y-direction).

As it is common in the state of the art, the dosing element 20 is connected via a line to a heated storage container 23 for the top layer material 24 which is in a flowable state. The container and the connecting line can be pressurized by a compressor 25 with compressed air for transporting the material of the top layer 24.

By means of the dosing element 20, the top cover material 24 can be applied to the utilization areas N of the base layer 14 (for example, in the area of the remaining circular punched areas) in such a way that the material flows apart under effect of gravity and adhesion and cohesion forces and —viewed in a radial direction—comes to a stop at the punch line 16. In this way, the finished top layer 24 will assume a convex shape with the greatest thickness T being about 0.5 mm to 2.0 mm, preferably between 1.0 mm and 2.0 mm (see FIG. 3). The dosing arrangement 3 is arranged over the full length thereof within a tunnel 26 which consists of a housing of for example sheet metal. A cross-sectional area at the entrance to the tunnel 26 from the unwinding arrangement 2 (not visible) is provided with a closure. The tunnel 26 in cooperation with the closure prevents particle-containing ambient air from entering the area in which the flowable top layer material 24 is applied since any deposition of such particles on the top layer and the adhesion thereof would result in a loss of quality or in the need for discarding the part.

Following the tunnel 26 of the dosing arrangement 3, there is another tunnel 27 of the hardening arrangement 4, the tunnels 26, 27 being joined in an air tight manner. Within the tunnel 27 of the hardening arrangement 4 radiators 28 are arranged, in the present case light radiators, which radiate UV light downwardly onto the web 10 moving over the surface of the table top plate 7, whereby the emitted UV radiation reaches the top layer material 24.

The top layer material 24 is isocyanate-free SnrCer® which is hardened by a chemical process. The material is a 100% solid body system of oligomers, monomers and photoinitiators By way of a polymerization the short molecules chains are interlaced to long three-dimensional structures. The initiator is the UV radiation which splits the photoinitiator into radicals whereby a polymerization with very high reaction speed, takes place. The transport speed of the web is selected with regard to the length of the tunnel in such a way that the residence time under the UV radiation is long enough to provide for a sufficient surface hardness or even a complete hardening of the top layer 24.

The tunnel 26 of the dosing arrangement 3 as well as the tunnel 27 of the hardening arrangement 4 are each provided at their top with suction stubs 19 which are connected to a suction device which is not shown.

In the hardening arrangement 4 which is disposed adjacent the winding arrangement 5, the web 10 provided with the finished domed labels is first still pressed down onto the table top plate 7 by a down-holder 30 and is then wound onto a roll 32 which is supported on a roll support structure together with the finished domed labels.

The method according to the invention is performed herein with the following steps:

The web 10 of the composite 11 is unwound successively from the roll 9 and provided in the dosing arrangement 3, by means of the dosing element 20, with the top layer material 24. An optical sensor element 33 arranged at the beginning of the dosing arrangement 3 detects in each case the front edge of a label and arranges for a position-accurate stopping of the web 10 in such a way that the dosing element 20 is disposed above the respective label. By means of the control arrangement 22, the stepwise advance of the web 10 is controlled depending either on the deposit time or the volume of the resin deposited. If several dosing elements 20 are arranged one after another in the transport direction of the web 10, which are depositing resin at the same time, the web 10 is advanced with each step corresponding to the number of labels being advanced. For increasing the efficiency, several webs 10 may be unwound in parallel and also be coated in parallel, that is, several narrow webs are provided with the top layer in side-by-side relationship or they may be disposed on one wide web which is later cut into several narrow webs or possibly further processed with several labels arranged thereon and provided at the same time with the top material layer 24.

The top layer material 24, which after its deposition on the base layer 14 is still flowable upon entry into the hardening arrangement 4, becomes increasingly harder as a result of the continuous irradiation by UV light in the tunnel 27 of the hardening arrangement 4. When reaching the exit cross-section 34 of the tunnel 27, the top layer material 24 is hardened at least to such a degree that, upon the subsequent winding of the web 10 onto the roll 32 the upper side of the top layer 24 does not adhere to the underside of the following layer of the roll 32.

Upon removal of the domed labels from the roll 32, which is removed from the arrangement 1 when it has reached a certain size, the labels consisting of the top layer 24, the base layer 14 and the adhesive layer 13 are lifted off the support layer 12. The support layer 12 is—as it is common practice—provided with a silicon coating so that the adhesive layer adheres to the base layer 14 but can be easily and completely removed therefrom. This is the classic case of a self-adhesive label.

Depending on the selected layer parameters (material, geometry, etc.) the process parameters of the arrangement 1 may be adjusted in a wide range via a control panel 35.

Alternatively to the described use of an isocyanate-free UV-hardening doming resin also a resin system on the basis of polyurethane may be used in connection with the present invention. In this case, the hardening occurs in the hardening arrangement 4 alone by air contact of the top layer 24, possibly with additional heating to shorten the hardening time. The web speed or respectively the length of the hardening arrangement 4 need to be adapted to the required hardening time.

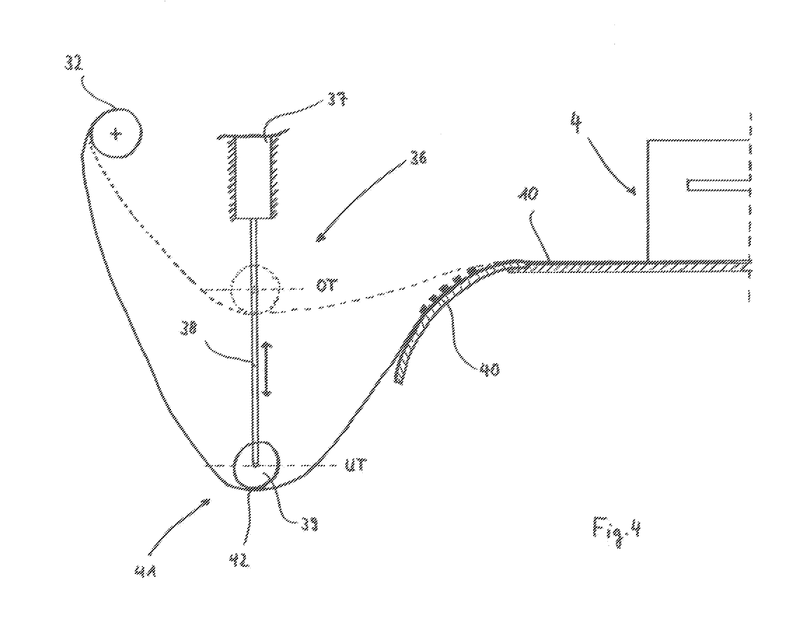

Different from the arrangement as shown in FIG. 1, the arrangement 1 shown in FIG. 4 only sectionally includes an accommodation arrangement 36 arranged between the hardening arrangement 4 and the roll 32 for winding the finished web 10. The accommodation arrangement 36 includes a stroke drive 37 in the form of a pneumatic cylinder at whose piston rod 38, that is, at the end thereof, a stroke element 39 in the form of a rotatably supported roller is arranged. The web leaving the hardening arrangement 4 is guided, via a curved guide structure 40, downwardly and is then redirected by the stroke element 39 upwardly toward the roll 32. The stroke element 39 therefore forms a loop 41 which is open upwardly with the lowest point of the web 10 being between the hardening arrangement and the roll 32.

In FIG. 4, the stroke element 39 and the piston rod 38 are shown at their lowest points UT. Starting at this position, the stroke element 39 is raised by the stroke drive 37 and transferred to its upper end position as indicated by the dashed line. The loop remains free of any forces. In the next instance however a drive for the roll 32 which is not shown may be activated so that the web material forming the loop 41 is wound up. The lower end 42 of the loop 41 then moves successively upwardly. Since the winding speed of the roil 32 is greater than the transport speed of the web 10 in the area of the hardening arrangement 4 (and also all the arrangements disposed upstream) the loop becomes continuously smaller and finally disappears when the web 10 is in the position shown in FIG. 4 by the dashed line just below the stroke element 39, which then is in the upper dead point position. At this moment, the roll 32 is stopped. At the same time however either the stroke drive 37 is again activated so as to cause downward movement of the stroke element 39 with a constant (small) force so as to form a new loop 41. Alternatively, the stroke drive 37 may be switched off to generate no downward force other than by its weight supported by the top side of the web 10 by which the loop is formed. In this way, the continuous movement of the web 10 out of the hardening arrangement 4 is ensured. It should be clear that at other locations of the web, further drive means for the movement of the web 10 through the arrangement 1 may be arranged.

In order to avoid an excessive curvature or bending of the labels on the web 10, the support layer 12 may be perforated in the intermediate area Z between adjacent labels or otherwise be weakened in order to cause greater bending at the perforated or weakened locations than in the area of labels where the web should be as flat as possible. Such a perforation or weakening also improves the behavior of the labels during their unwinding since a complete contact with the surface of the object to be marked is ensured thereby.

### LISTING OF REFERENCE NUMERALS

| | |
|---|---|
| 1 | Arrangement for the manufacture |
| 2 | Unwinding arrangement |
| 3 | Dosing arrangement |
| 4 | Hardening arrangement |
| 5 | Rewinding arrangement |
| 6 | Frame |
| 7 | Table top plate |
| 8 | Roller support |
| 9 | Roll |
| 10 | Web |
| 11 | Composite |
| 12 | Support layer |
| 13 | Adhesive layer |
| 14 | Base layer |
| 15 | Thickness |
| 16, 16′ | Stamping line |
| 17 | Waste area |
| 18 | Drive unit |
| 19 | Transport roller |
| 20 | Dosing element |
| 21 | Positioning arrangement |
| 22 | Control arrangement |
| 23 | Storage container |
| 24 | Top layer |
| 25 | compressor |
| 26 | Tunnel |
| 27 | Tunnel |
| 28 | Radiator |
| 29 | Suction stub |
| 30 | Downholder |
| 31 | Roll support |
| 32 | Roll |
| 33 | Optical sensor element |
| 34 | Exit cross-section |
| 35 | Control panel |
| 36 | Accommodation arrangement |
| 37 | Stroke drive |
| 38 | Piston rod |
| 39 | Stroke element |
| 40 | Guide structure |
| 41 | Upwardly open loop |
| 42 | Lower end |
| N | Utilization area |
| T | Thickness |
| Z | Intermediate area |

What is claimed is:

1. A method for the manufacture of labels consisting of a base layer (14), an adhesive layer (13) disposed at the bottom side of the base layer (14), a top layer (24) connected to the top side of the base layer (14) and a support layer (12) removably attached to the adhesive layer (13), the method comprising the following steps:
a) applying to a composite (11) consisting of the base layer (14), the adhesive layer (13) and the support layer (12) at a surface thereof opposite the adhesive layer (13) at different locations which are spaced from one another, by means of a dosing arrangement, a quantity of a top layer material (24) in a flowable state so that by a flow distribution of the flowable material, a final form of the top layer (24) is formed on the surface of the base layer (14),
b) at least partially hardening the top layer material (24) in the final form thereof, the composite (II) being maintained in an essentially horizontal orientation from the time of the application of the top material layer to its at least partial hardening, and
c) supplying the composite (11) consisting of the base layer (14), the adhesive layer (13) and the support layer (12) in the form of a web to the dosing arrangement.

2. The method according to claim 1, wherein the composite (11) consisting of the base layer (14) the adhesive layer (13) and the support layer (12) is unwound form a storage roll (9) before the application of the top layer and, after the application of the top layer (14), the composite layer (13), the support layer (12) and the at least partially hardened top layer (24) is re-wound onto a rewinding roll (32).

3. The method according to claim 1, wherein the composite (11) consisting of the base layer, the adhesive layer (13) and the support layer (12) is unfolded from a storage packet in the form of a leporello before the application of the top layer material (24) and, afterwards, the composite (II) consisting of the base layer (14), the adhesive layer (13), the support layer and the at least partially hardened top layer (24) is again folded into the finished pocket in the form of a leporello.

4. The method according to claim 1, wherein the web (10) comprises a plurality of narrow webs arranged in side-by-side relationship and in a direction transverse to the transport direction and the top layer material (24) is applied to the parallel webs at several locations side-by-side.

5. The method according to claim 4, wherein onto the web (10) or on a plurality of parallel webs, top layer material (24) is applied at the same time at several locations which are disposed in travel directions one behind another.

6. The method according to claim 1, wherein exclusively utilization areas (N) of the base layer (14) are provided with the top layer material (24) but areas between the adjacent utilisation areas (N) remain free of the top layer material (24).

7. The method according to claim 1, wherein the top layer of each label has a convex shape.

8. The method according to claim 1, wherein the top layer material (24) is applied by means of a nozzle in the form of a flow wherein the discharge cross-section of the nozzle is preferably substantially smaller than the thickness of the top layer material (24) in its final shape.

9. An arrangement for the manufacture of labels, consisting of a base layer (14), an adhesive layer (13) disposed on the bottom side of the base layer (14), a top layer connected, to the top side of the base layer (14) and a support layer (12) removably attached to the adhesive layer (13), comprising:
a) a dosing arrangement (3) via which a quantity of a top layer material can be applied to a surface of the base layer (14) opposite the adhesive layer which base layer (14) forms a composite with the adhesive layer (13) and the support layer (12),
b) a moving arrangement (21) for moving the composite (11) comprising the base layer (14), the adhesive layer (13) and the support layer (12) relative to the dosing arrangement (3) in such a way that the top cover material is applicable to the composite (11) at different spaced locations,
c) a hardening arrangement (4) in which the top layer material can be at least partially hardened by means of at least one of irradiation, temperature, pressure, air contact and the addition of a chemical, wherein the composite (11) remains oriented essentially horizontally while in the dosing arrangement, the hardening arrangement and also in the areas in between, and
d) a transport arrangement with transport rollers via which the composite consisting of the base layer (14), the adhesive layer (13) and the support layer (12), which is present in the form of a web (11) can be moved at least up to the dosing arrangement (3).

10. The arrangement according to claim 9, comprising a roll support (8) for a roll (9) consisting of the web (10).

11. The arrangement according to claim 9, including a roll support structure (31) for supporting a roll (32) with driving means for winding up the web with the hardened top layer (24).

12. The arrangement according to claim 9, wherein at least one of the hardening arrangement (4) and the dosing arrangement (3) includes a tunnel (26, 27) by which air-based particles can be kept away from the surface of the top layer (24) before it is hardened.

13. The arrangement according to claim 9, wherein at least one dosing element (20) of the dosing arrangement (3) from which a flow of the top cover material (24) can be discharged is movable in a direction parallel or transverse to the transport direction.

14. The arrangement according to claim 9, wherein between the hardening arrangement and a roll (32) for winding up the web (10) an accommodation arrangement (36) is disposed which includes a stroke element (39) which acts on the top side of a loop (41) formed by the web (10), so that, with a downward movement of the stroke element (39), a constant force, in particular the weight force of the stroke element (39), is effective to maintain the loop (41) under tension whereas the stroke element can be raised by a stroke drive (37) in order to wind the web (10) onto a web roll (32) free from outer forces.
